(19) United States
(12) Patent Application Publication
(10) Pub. No.: US 2010/0266782 A1
(43) Pub. Date: Oct. 21, 2010

(54) Method of powder coating-multiple layer powder applications of thermoset powder in a single booth for conductive and non-conductive substrates

(76) Inventor: Robert Langlois, Vaughan (CA)

Correspondence Address: RICHES, MCKENZIE & HERBERT, LLP, SUITE 1800, 2 BLOOR STREET EAST, TORONTO, ON, M4W 3J5, CA

(21) Appl. No.: 12/385,647

(22) Filed: Apr. 15, 2009

(51) Int. Cl. C08F 2/46; B05D 3/02

(52) U.S. Cl. 427/521; 427/195

(57) ABSTRACT

A method of powder coating application in which two thermo set powder resins can be applied to conductive substrates, non-conductive substrates or combinations of both within a single powder-coating booth and then subsequently co-cured. The substrates are cleaned, pre-treated if metal, dried, pre-heated and the first and second application of thermo set powder is done and then the powders are co-cured with heat.

### FIELD OF THE INVENTION

The present invention relates to a method of powder coating application in which two thermo set powder resins can be applied to conductive substrates, non-conductive substrates or combinations of both within a single powder-coating booth and then subsequently co-cured.

### BACKGROUND OF THE INVENTION

Industries such as the appliance industry are striving to look for new and more aesthetically pleasing surface finishes for their major appliance lines. Currently the appliance industry and in general the powder industry has constructed its powder coating lines to accommodate a mono-coat application of thermo set powder to conductive substrates. If successive layer stacks are required in such mono-coat facilities, the substrates must loop the production cycle to achieve this, whereby production times are increased significantly and inefficiencies arise with the inability to plan long production runs. Although it is possible to use prior art to apply two thermo set powders within a single booth, the prior art yields parts which do not meet the aesthetics nor functionality required of the part, which could be expected using two booths and two cures. This is primarily due to both thermo set powders blending together during the prior art application process because no clear physical delineation between the two layer stacks applied is created and thus not being able to achieve the intended look of a two booth two cure application. The present invention has overcome this issue. With the advancement of thermo set resin technology, the range of aesthetic and functional performance offerings includes metallic and other finishes that require a two coat application, consisting of an initial layer the base coat and a second layer called the top coat application of thermo set resins to the substrate. The benefits to existing operators of mono-coat powder coating lines of this invention is significant, in that they will be able to use the existing powder coating line and with minimal investment, and additionally not having to increase plant size or existing powder line foot print, will be able to offer a two coat process at a much more competitive price than the traditional two booth, two oven cure process. Greenfield powder coating lines will also be significantly benefited from this invention, in which the initial capital cost will be significantly less than the traditional two booth, two-cure oven process, and operationally costs will be significantly less. As a by product of this invention, the combining of the application of two thermo-set reins in one powder booth and the subsequent co-curing therein produces a much more aesthetically pleasing part, it is noticeable smoother in appearance. Another by product of this process is the increase in first pass yield, as production steps are reduced, and thus less chance for dirt and other paint issues to arise.

Environmentally this invention will significantly reduce green house gasses by using less electricity and/or natural gas.

The present invention has eliminated the requirement for one paint booth and one curing oven, thus reducing the capital cost of equipment, reducing the energy consumption to cure the thermo set resins and the amount of floor space required for the production line, while achieving a two coat powder application in a single paint booth. It finds application in the automotive, plumbing, recreational, appliance, hardware and electronics industries.

Additionally the present invention offers the ability to not only apply two thermo set resins in one booth to conductive substrates but also to non-conductive substrates.

### DESCRIPTION OF THE PRIOR ART

U.S. Pat. No. 6,921,558 which issued Jul. 26, 2005 to Fredericksen, discloses a method for powder coating articles which includes the steps of preheating the article, coating the article with a polymeric powder coating having a cross-linking temperature that is above the preheating temperature and then curing the article having the powder coating applied thereto at a curing temperature, a system is further described.

Fredericksen proposes that this process is for plastic or non-conductive substrates, and would not be intended to be used for conductive or metal substrates. Fredericksen further claims that subsequent applications of powder on the article are done after the first layer has been applied and fully cured. Fredericksen describes a process for achieving multiple layers using multiple powder application booths and multiple curing ovens. The present invention is intended not only for use with plastic substrates but also metal substrates and allows for two thermo set resins to be applied in one booth and subsequently co-cured.

U.S. Pat. No. 4,758,450 which issued Jul. 19, 1988 to Czech, discloses a method for application of plastic powder using a sintering bath in which a high temperature plastic is pre-heated to a temperature range of 170. Degree C. to 230 Degree C., immersing the substrate from 1-5 seconds in a vertical sintering bath, then removed and allowed to cool.

Czech claims that the process is for non-conductive materials. The process of Czech posses issues of proper cure temperatures and dwell times associated with thermo set resins, which typically require curing times of 20 minutes or longer at a temperature of 325 Degree F. (163 degree C.) or Higher. As well this process can be repeated to create layers, but in doing so must go through multiple iterations rather than through a single painting booth operation. The Czech materials are not thermos set resins, but plastic powders that will cure and become tackless at ambient room temperature rather then the art of thermo set resins which require direct heat at a sufficient temperature and dwell time within a defined curing apparatus, and oven.

U.S. Pat. No. 5,021,297 which issued Jun. 4, 1991 to Rhue, discloses a method for application of powder to plastic substrates in which the part is preheated at a temperature of 300 Degree F. (149 degree C.) to 400 degree F. (204 degree C.) for at least 15 minutes and the thermo set powder is applied and then cured. To achieve a second coat of thermo set powder the process must be repeated. This process requires multiple booths and multiple cure ovens, and is not intended for use in coating steel or conductive materials. Rhue further claims that if the plastic substrate is to be electro statically painted, then the substrate must be either impregnated with graphite particles or by using electrically conductive fibre reinforcement. Optionally a conductive primer or wash solution. Rhue further claims that a finish coat can be achieved by the application of a liquid coat, which is sprayed or brushed, and then cured at a temperature from 180 Degree F. to 325 degree F. (82. degree C. to 163. decree. C.) These finish coats may include multiple applications and cures of both base and clear coats. The present invention does not require the use of conductive primers, nor any conductive fibres or particles within the plastic substrates to enable electrostatic powder spraying. Further, the present invention is suitable for both conductive (metal) and non-conductive (Plastics) substrates. The Present invention further allows for the use of thermo set powders to provide a high quality automotive finish, where no liquid applications are required. The present invention allows for the achieving of a high quality finish with a single pass through one powder booth in which two layers the Basecoat and the Topcoat are applied, and then subsequently co-cured.

U.S. Pat. No. 5,338,578 which issued Aug. 16, 1994 to Leach, discloses a method for achieving a high-gloss finish on a compression molded substrate by preheating the substrate above the melting temperature of a subsequently applied coating powder and applying a first layer of powder to the heated surface and then curing the layers by using infrared radiation or by forced heated air sufficient to cure, and if desired subsequently electro statically applying a second coating.

Leach claims this process is for compression molded substrates having a specific gravity of not more then 1.4, where the present invention is suitable for all conductive (metal) and non-conductive substrates (Plastics) and is unaffected by the requirement of specific gravities of less then 1.4, and where the non-conductive materials may have a specific gravity of 1.4. Further Leach claims that as a requirement the substrate must comprise a vinyl ester or polyester resin including from 75 to 130 parts by weight of hollow filler per 100 parts by weight of said vinyl ester or polyester resin, as wherein the present invention does not require any vinyl ester or polyester resin nor any hollow fillers. Leach further claims that the preferred embodiment includes a conductive powder, where the present invention does not require a conductive primer. Leach further claims that in the preferred embodiment, that the conductive primer is required for the secondary step of applying the second coating, wherein the present invention does not require a conductive coating for application of the second powder coat.

U.S. Pat. No. 5,344,672 which issued Sep. 6, 1994 to Smith, discloses a process for powder coating plastic product which parts are heated at a temperature and for a time sufficient to degas the substrate, and then coated with powder, heated to cure the powder. Smith claims the preferred embodiment will include a water-based electrically conductive coating to be first applied, which will be cured while the substrate is heated to degas the substrate sufficiently.

Smith claims that this process is for plastic substrates, wherein the present invention is intended for both plastic and metal substrates. Smith further claims the preferred embodiment to have a conductive primer application, wherein the present invention does not require. Smith further claims where the substrate must be preheated for at least 22 minutes, wherein the present invention can be preheated for less time. Smith further claims that the preheat temperature must be above the melt point of the powder and below the cure temperature, wherein the present invention no such restriction is placed an in fact in some situations it is desired and required that preheat at cure temperatures are required.

U.S. Pat. No. 5,470,609 which issued Nov. 28, 1995 to Leach, discloses a process for the repair of plastic substrates utilizing powder-coating compositions. A process in which requires the preheating of the surface, application of powder and the curing of the powder. This process is intended for non-conductive substrates, offering repairs to non-conductive substrates. This process is designed as a single application of thermo set powder as a means to effect a repair.

Leach claims that upon the removal of excess powder the part may then be processed with known art to apply a finish coat, wherein the present invention is a process whereby two thermo set powder coats are applied in a single booth then co-cured to provide a superior finished painted part. Further the invention is intended for all conductive (metal) or non-conductive substrates (Plastic).

U.S. Pat. No. 5,565,240 which issued Oct. 15, 1996 to Smith, discloses a method for powder coating plastics in which the part is heated at a temperature and for a time sufficient to degas the substrate, and then coated with a powder and heated to cure. In the preferred embodiment, a water-based electrically conductive coating is first applied to a phenolic composite, and cured while the substrate is heated to degas. This process is intended for single layer application, and not intended for a metal, and or a multi-layer application process.

Smith claims that this process is for plastic substrates, wherein the present invention is intended for both plastic and metal substrates. Smith further claims the preferred embodiment to have a conductive primer application, wherein the present invention does not require. Smith further claims where the substrate must be preheated for at least 22 minutes, wherein the present invention can be preheated for less time. Smith further claims that the preheat temperature must be above the melt point of the powder and below the cure temperature, wherein the present invention no such restriction is placed an in fact in some situations it is desired and required that preheat at cure temperatures are required.

U.S. Pat. No. 5,516,551 which issued May 14, 1996 to Anderson, discloses a process for coating edges with primer. A process in which the part is pre heated to a temperature near or above the cure temperature of the powder for purposes of degassing, reducing the temperature of at least the edge to a temperature below the powder cure temperature, applying a fine size powder coating material to the edge and heating the applied powder coating to a temperature at or above the minimum cure temperature.

Anderson claims that this process is for SMC substrates, as wherein the present invention covers all plastics and metals. Anderson further claims that this process is suitable for priming or preparing edges of such materials, wherein the current invention provides for a class a automotive finish. Anderson claims that this process is a single application of primer, wherein the present invention may include a primer basecoat with a subsequent topcoat achieved within a single powder booth and subsequent cure.

U.S. Pat. No. 6,254,751 which issued Jul. 3, 2001 to Reiter, discloses a method for multi-layer application of an electrophoretic coating material, preferred embodiment of liquid bath, and a powder coating material.

Reiter claims that at least one coat the initial layer is a electrophoretic coating, wherein the present invention this is not required nor part of the preferred embodiment. The Reiter invention is solely for conductive materials, wherein the present invention is suitable for multiple layers on both conductive and non-conductive substrates solely utilizing thermo-set powder resins.

U.S. Pat. No. 6,537,610 which issued Mar. 25, 2003 to Springer, discloses a process for applying a dual-layer protective coating to steel suspension components of an automobile, wherein the present invention is suitable for both conductive and non-conductive substrates. Wherein the current invention provides for a class a automotive finish. Wherein the present invention completes the application of two thermo set powders within one apparatus (the powder booth).

Springer claims the first coat is an epoxy based resin, wherein the present invention can utilize all thermo set resin chemistries, including but not limited to polyurethane's, acrylics.

Springer claims the second application is done within a fluidizing bed, wherein the present invention completes both layer applications by means of an electrostatic spray process.

Springer claims that the initial epoxy-based powder coat must be partially cured in an oven prior to the second application of powder, wherein the present invention provides for application of both layers in a single apparatus with a subsequent co-curing in a single oven.

U.S. Pat. No. 6,214,421 which issued Apr. 10, 2001 to Pidzarko, discloses a method of powder coating at least one surface of a non-conductive object. Pidzarko claims to apply layer of moisture to the non-conductive part for purposes of adhesion of the powder to the surface and subsequent curing therein, wherein the present invention relies on preheating the part and grounding the part for conductivity prior to the application of powder. Pidzarko claims that further layers of thermo-set resins are applied using moisture for adhesion and done in successive powder booth operations and subsequent cures at sufficient temperature, wherein the present invention applies multiple thermo set resins in a single powder booth and subsequent co-curing of the thermo-set resins.

U.S. Patent Application 20070224343 applied Sep. 27, 2007 by Langlois, discloses a method of powder coating thermo powder resins to non-conductive substrates. The substrates are pre-heated to or above the cure temperature of the powder with a subsequent application of thermo set powder resin and the further curing of the substrate.

To a achieve a multiplayer thermo set application the preferred embodiment of this application will require a secondary booth application of thermo set powder upon the cured initial or base coat, followed by another cure, wherein the present invention allows for the application of two layers of thermo set resins within a single powder booth and subsequently co-cured. Additionally said present invention is intended for both conductive and non-conductive substrates.

U.S. Patent Application 20040253373 applied Dec. 16, 2004 by Langlois discloses a method of powder coating thermo powder resins to non-conductive substrates. The substrates are pre-heated to or above the cure temperature of the powder with a subsequent application of thermo set powder resin and the further curing of the substrate.

To a achieve a multiplayer thermo set application the preferred embodiment of this application will require a secondary booth application of thermo set powder upon the cured initial or base coat, followed by another cure, wherein the present invention allows for the application of two layers of thermo set resins within a single powder booth and subsequently co-cured. Additionally said present invention is intended for both conductive and non-conductive substrates.

U.S. Patent Application 20030113476 applied Jun. 19, 2003 by Fredericksen, discloses a method of powder coating plastic articles including steps of preheating the article, applying a thermo set powder resin and curing.

Fredericksen claims the cooling of the article prior to the subsequent curing, wherein the present invention does not require a cooling period. Fredericksen claims the article to be a plastic or non-conductive article, wherein the present invention is applicable for both non-conductive and conductive articles. Fredericksen claims that a second thermo-set resin can be applied by repeating of the process of preheat, application and cure, wherein the present invention allows for both applications to take place in one booth with a single co-curing of both layers. Fredericksen claims where the article is non-grounded wherein the present invention does give regard to grounding of both conductive and non-conductive articles.

U.S. Patent Application 20080289968 applied Nov. 27, 2008 by Menovick, discloses a method of coating a substrate that includes the steps of applying an electrocoat to the substrate, and applying a powder primer to the electrocoat then applying a topcoat onto the powder primer. The topcoat typically includes a powder basecoat and a clear coat, and then all are simultaneously cured in an oven.

Menovick claims as part of the application process there is a requirement of an electrocoat initial application; the present invention does not require an electrocoat application. The requirement of electrocoat requires a metal substrate; the present invention is suitable for both metal and plastic substrates.

Menovick claims that a powder primer coat and a topcoat, with the topcoat comprising up to two additional powder coats, wherein the present invention is two applications of powders not necessarily requiring the basecoat to be a primer, and not necessarily the top coat being a clear coat powder. The present invention relies on the ability to gel the initial powder layer so as to define a distinct layer so as to prevent a dry mix of the subsequent next powder application, as is the case with Menovick, whereby the present invention ensures the integrity of the coatings performance and providing the required aesthetics, whereas Menovick will yield inconsistencies in performance and aesthetics due to the dry powders blending and mixing together.

Menovick claims that the basecoat comprises a flake additive which is then applied onto the primer layer, where the flake additive comprises at least one of a mica flake and a metal flake, wherein the present invention does not require any flake in either the basecoat nor topcoat.

Menovick claims the powder basecoat is to have a film build between the range of 40 microns and 50 microns, wherein the present invention has not preset limitations on film build and can be more or less than this range.

### SUMMARY OF THE INVENTION

It is therefore an object of the present invention to provide a process which allows for the application of a dual coat of thermo set powder resin in a single powder coating booth, Basecoat and Top Coat, and the subsequent co-curing in a single oven providing a decorative and/or functional coated Surface to conductive and non-conductive substrates thereby providing a first class surface finish in a wide variety of powder material chemistries encompassing a variety of colours, metallic and textures.

A further object of this invention is to provide an apparatus for a process, which provides a first class surface finish, which is independent of external environmental factors such as dirt, humidity, and temperature fluctuations so that a reproducible finish is achievable.

A Further object of this invention is to provide an apparatus which will allow for the application of two coats of thermo set Resin in a single pass, the Base Coat and Top Coat, and the subsequent co-curing of the two applied thermo set resins in a single curing oven.

It is yet a further object of this invention is to provide a suitable painting process to eliminate or replace existing processes which use paints, primers and which emit VOC's.

A still further object of this invention is to provide a cost effective method of applying a decorative or functional painted surface to conductive and plastic or non-conductive substrates.

A further object of this invention is to allow existing mono-coat powder coating lines to incorporate the process of applying two coats of thermo set resins in a single booth, thus significantly increasing the finishing options while reducing the requirement for significant capital investment and floor space required.

A further object of this invention is to allow existing two booth powder coating lines to incorporate the process of applying two coats of thermo set resins in a single booth, thus eliminating the need for a second booth and associated cure oven, which will significantly reduce costs and process time.

A further object of this invention is to reduce the overall steps required to provide a two-coat application of thermo set resin providing a first class finish to conductive and non-conductive substrates.

It is a further object of this invention to reduce the amount of curing ovens which typically would require one for each thermo set application, which are very expensive and which require a significant amount of energy.

It is still an object of this invention is to provide an inline; enclosed environmentally controlled apparatus which reduces or eliminates airborne contamination which is associated with traditional powder coating apparatus.

It is still a further object of this invention to allow for the application of two thermo set powders within a single powder coating booth and minimize or eliminate any cross-contamination of the thermo set resins within the application booth.

The present invention relates to a process and an apparatus, which increases the efficiency of the application of thermosetting powder coatings on conductive and non-conductive substrates.

The present invention provides an improved process and apparatus for increasing the efficiency and processing of the application of multiple layers of thermosetting powder coatings on plastic substrates such as nylon, PCABS and TPO and metal and other conductive substrates. It provides a multi-step process to ensure a highly reproducible finish meeting a minimum of first class surface finish standards, which are acceptable within the appliance industry and other such industries such as the automotive industry.

The process and apparatus allow for the coating of hanging and or fixtured substrates moving along a continuous overhead or inverted conveyor system which travels through a contained preparatory and paint booth system to ensure cleanliness, temperature control and humidity for the purposes of providing a highly reproducible environment.

The preferred embodiment couples the system with a continuous overhead or inverted conveyor system which may be an indexing type or power and free conveyor system. The system allows the operator or plc controls to probe and measure the surface temperature of the substrate at various intervals in the process.

The design of the system incorporates a cleaning booth which chemically cleans and rinses the plastic or non-conductive substrates or in the case of metal substrates will chemically clean and apply a zinc phosphate, iron phosphate or other conversion coating for the purposes of corrosion resistance or other durability standards to the metal substrates and then blow dries the substrates with warm air to remove any excessive moisture.

The substrates are transported via the conveyor system through a control tunnel in which the parts are measured via a temperature probe which in turn controls a IR/Convection/Microwave or any combination therein heating system which is sufficient to maintain the surface and core temperature of the substrates to a specified temperature which should be sufficient to allow for the fist layer of powder coating to gel immediately upon contact with the substrate.

The substrates are then powder coated by an electrostatic and thermal attraction powder spray method at a sufficient volume and for a sufficient time to coat the substrates in accordance with the specified film desired. Once the substrates have been coated with the first layer of thermosetting powder, and the powder has immediately gelled upon contact, the substrates are then subjected to a second application of thermosetting powder within the same powder booth at a sufficient volume and for a sufficient time to coat the substrates in accordance with the specified film desired.

Once the substrates have received the two applications of thermosetting powders, they are then transferred to the curing oven via the overhead or inverted conveyor system. The curing oven employs either an IR heating system or a convection oven or a combination thereof, in which when used the IR system can bring the surface temperature of the part to a curing temperature immediately thus reducing the length of time necessary in the convection oven. The method of dual coat within a single booth and co-curing of the thermo set powders offer advantages in reduced powder line footprint and length, shortened processing time, reduced energy cost, reduced capital cost, and as a by product of this invention the thermo set powders aesthetic appearance over traditional two booth, two cure process is noticeable enhanced.

The substrates leave the curing oven and move to a subsequent process stage in which the substrates move to a temperature and humidity control tunnel with an IR or convection heating controlled by temperature probes measuring substrate surface temperatures or alternatively, the substrates will exit the process for unracking.

The substrates which proceed through the control tunnel will enter a subsequent powder coating station wherein a third application of powder will be layered onto the existing two cured or semi cured base coat and mid coat. The application will be for a sufficient time and volume to allow for the sufficient coating of the substrate.

Once the substrates have been coated, they are then transferred to the second curing oven via the overhead or inverted conveyor system. The curing oven use IR heating, convection or a combination of the systems. The IR system when employed brings the surface temperature of the part to a curing temperature immediately thus reducing the length of time necessary in the convection oven. The combination of heating systems can aid in the overall reduction in the length of the cure oven making the process more efficient.

The substrates then leave the second curing oven via the overhead or inverted conveyor system to the unracking station.

### BRIEF DESCRIPTION OF THE DRAWINGS

FIG. 1 illustrates in schematic form a machine designed to carry out the process and the method of the present invention.

FIG. 2 illustrates a typical set up of a dual coat single booth thermo set application.

### DETAILED DESCRIPTION OF THE PREFERRED EMBODIMENT

The drawings show a process and apparatus for the application of thermosetting powders to conductive and non-conductive substrates by means of an inline coating system which controls the environment inside the apparatus to form ideal coating conditions while maintaining the substrate temperature at exacting levels necessary for the application of thermosetting powders. The substrates may be nylon, Polycarbonates, TPO, PET, RIM, PCABS and ABS materials and all other conductive substrates, including steel, aluminum, and stainless steel.

The apparatus and process allow for a multiple layer of thermosetting powders to be applied within a single powder coating booth, producing various surface finishes including high gloss, gloss, matte, textured and metallic surface finishes.

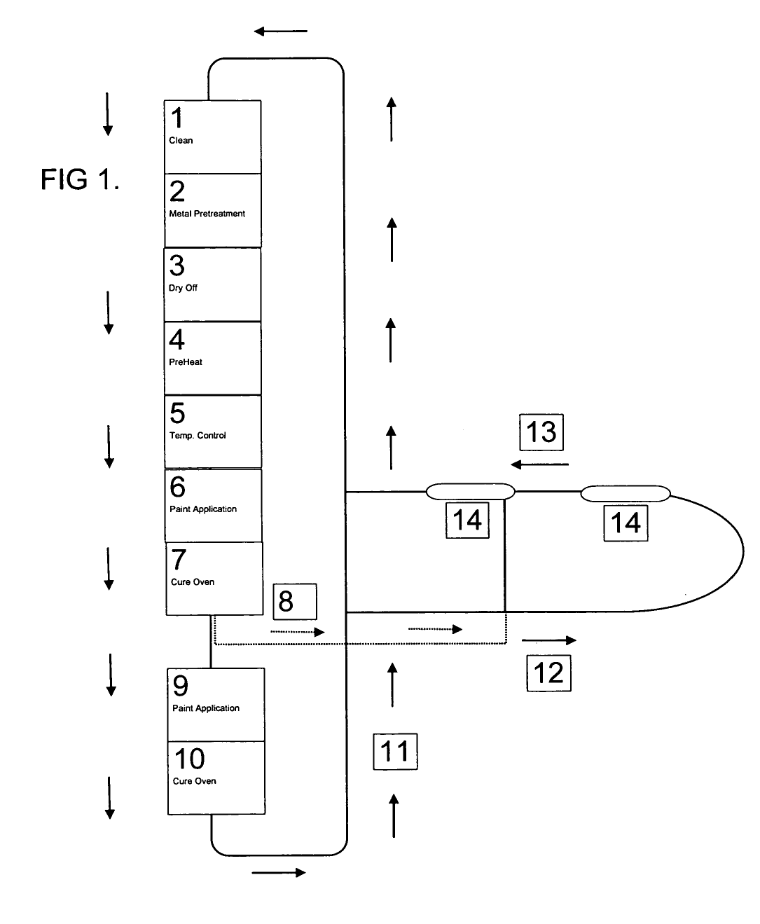

FIG. 1. shows in schematic form a machine designed to carry out the process or method of this invention.

The machine has a continuous conveyor 11, which has both an infeed or racking area 13 for the purposes of placing substrates on carriers 14 to be moved through the process via the conveyor 11.

There is an outfeed or un-racking area 12 designed for the purposes of removing the completed substrates from the carriers to prepare for the next batch of substrates to be racked in area 13.

The process is a continuous conveyor system 11 where the substrates enter a spray wash and rinse booth 1 where the substrates are washed and rinsed with water and or chemically cleaned. The substrates then travel via the continuous conveyor 11 to the next station 2 where the substrates if they are metal or conductive may or may not be pre-treated to prevent such conditions as corrosion via either an iron phosphate or zinc or other pre-treatment such as a conversion coating.

The substrates will then travel via the continuous conveyor 11 to the next station 3 where the substrates are dried to remove any excess rinse materials via a warm air blower system.

The substrates travel via the continuous conveyer 11 to the next station 4 where the substrates will be preheated to a temperature in excess of the gel point of the thermo set powder. the substrates will receive convection or IR or microwave heating or any combination therein at a sufficient temperature to ensure that the thermo set powder will gel on the substrate upon contact. The length of the preheat will depend on the composition and mass of the substrate. Upon exiting the station 4, the substrates move via the overhead or inverted continuous conveyor 11 into a temperature control tunnel 5 with the temperature controlled by IR devices. The IR devices in tunnel 5 will maintain the substrate temperature necessary for the proper subsequent application of further processes.

The temperature control of tunnel 5 is controlled via an automatic passive temperature probe, which monitors the surface temperature of the substrate parts at desired intervals. The temperature of tunnel 5 maintains the substrate surface temperature of between 100 degrees Fahrenheit and 400 degrees Fahrenheit prior to exiting tunnel 5.

The substrates move via the continuous overhead or inverted conveyer 11 and enter station 6 for the purposes of powder coating application. The pre-heated substrates in station 6 are sprayed with one or more electrostatic powder coating paint gun or paint guns in an automatic fashion. The application of the powder occurs while the surface temperature of the part is below the curing temperature of the powder and at a temperature but a sufficient temperature to ensure that the thermo set powder is gelled onto the substrate. By doing this the thermo set powder has formed a distinct and defined layer which will enable the immediate application of a secondary thermo set powder thus allowing the powders to remain separated while achieving the same or better appearance achieved in the more traditional two booth known art. Once the first application of thermo set powder has been applied in station 6, a secondary application of powder is immediately made using a secondary bank of electrostatic powder gun or guns in an automated fashion.

Once the substrates have been powder coated, they travel via the continuous overhead or inverted conveyor system 11 to station 8 which may employ a mixture of IR units to bring the surface temperature of the part immediately to the curing temperature of between 100 degrees Fahrenheit and 375 degrees Farenheit and where the convection oven will maintain the surface and core temperature of the part for a period long enough to ensure the proper co-curing of both thermo set powders, or solely by convection either gas or electric curing systems, again for an appropriate time to ensure full co-curing of the two thermo set powders.

The substrates travelling via the overhead or inverted continuous conveyor 11 then exit the coating system via off-feed conveyor system 8 in which case the substrates will move to un-racking area 12 or continue to tunnel 9 for further processing. Further processing will entail the application of an additional thermo set powder coat, which is usually a clear coat or top sealer. The substrates moving via the continuous overhead conveyer enter station 9 for the purposes of powder coating application in which the parts in station 9 are sprayed with one or more electrostatic powder coating paint gun or guns in an automatic fashion.

Once the substrates have been powder coated, they travel via the continuous overhead or inverted conveyor system 11 to station 10, which is a curing oven employing a mixture of IR units which bring the surface temperature of the part to the curing temperature and where the convection oven maintains the surface and core temperature of the part for a period sufficiently in duration to ensure complete curing of the thermo set powder, or may be cured solely by convection and/or IR for a duration sufficient to ensure the full curing of the thermo set powder. Once the part is cured in station 10, the parts travel via the overhead or inverted conveyor system 11 to un-racking area 12 where the carriers 14 are unloaded.

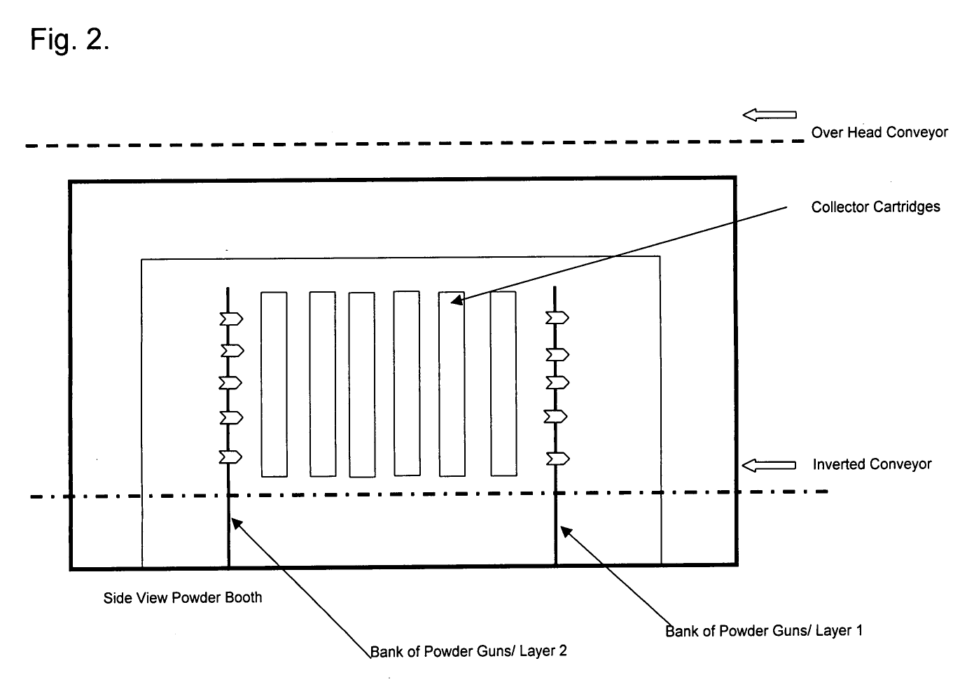

FIG. 2 illustrates the basic set up of the dual coat powder coating booth, this booth may include both reclaim for either or both thermo set powders and may employ automatic guns and computer control systems as well as oscillators and robotics. The booth may be further configured to allow for double-sided paint application where the substrates are sprayed both sides by opposing guns or by robotic application.

In summary, the present method allows for a smaller apparatus, more efficiency and reduces energy consumption and provides a superior thermosetting powder coated substrate over the prior art.

While the present invention describes and discloses the preferred embodiment, it is understood that the present invention is not so restricted.

I claim:

1. A method for the application of two thermo set powders in a single powder coating booth to conductive and non-conductive substrates comprising the following steps:
(a) cleaning said substrates to remove any contaminants or mold release agents therefrom;
(b) If a metal substrate pre-treatment for corrosion resistance;
(c) Dry the substrates to remove water & moisture;
(d) Preheat the substrate to sufficiently allow the first application of thermo set powder to gel immediately upon contact with the substrate;
(e) Immediately apply the second application of thermo set powder within the same powder booth.
(f) Co-cure both thermo set powders with heat; and

2. A process as claimed in claim 1 further including applying an additional layer(s) of thermosetting powder to the substrate while said substrate is still hot upon the completion of the co-bake cure of the initial two single booth application of thermo sets.

3. A process as claimed in claim 1 that the parts both metal and plastic are grounded.

4. A process as claimed in claim 1 the thermo set powders may be of any chemistry, such as epoxies, polyurethane's, acrylics.

5. A process as claimed in claim 1 where the layers of top coat and base coat could be any combination of primer, clear, solid, texture or metallic paints in no particular order.

6. A process as claimed in claim 2 further including the additional step of curing said additional layer of thermosetting powder with heat.

7. A process as claimed in claim 1 wherein said substrates are conductive, non-conductive such as plastics and or combinations.

8. A process as claimed in claim 1 wherein said substrate is moved through the sequence series of steps by the use of a continuous overhead or inverted conveyor.

9. A process as claimed in claim 1 wherein said substrate is cleaned in a cleaning booth, which spray rinses, said substrates.

10. A process as claimed in claim 1 wherein said substrate if metal may or may not receive a pre-treatment to prevent corrosion or some other type of conversion coating.

11. A process as claimed in claim 1 wherein the said substrate is blown dry with warm or dry air to remove water and moisture.

12. A process as claimed in claim 1 wherein said substrate is moved into a preheat oven which will elevate the surface temperature of the substrate to a sufficient temperature to ensure that the thermo set powder will gel on the substrate upon immediate contact during the spray application.

13. A process as claimed in claim 1 wherein said substrate is moved through a controlled tunnel in which the surface and core temperature of said substrate may be measured via a temperature probe which controls an infrared heating system which maintains the surface and core temperature of the substrates at a specified temperature.

14. A process as claimed in claim 1 wherein the substrates are moved into a powder coating both and said thermosetting powder is applied to said substrate through an electrostatic powder spray at a sufficient volume and for a sufficient time to coat said substrate in accordance with the specified film desired. The substrate temperature must be at a sufficiently temperature to ensure that the first coat will gel immediately on the substrate upon contact.

15. A process as claimed in claim 1 wherein said thermosetting has gelled sufficiently to prevent mixing of powders upon the second application of thermo set powder within the same booth. The gelling of the first layer provides a defined barrier to prevent mixing and thus will enable the thermo set powders to achieve the desired aesthetic appearance that otherwise would not be possible.

16. A process as claimed in claim 1 wherein said substrate will immediately receive a second thermo set powder application in the same powder coating booth, and or two consecutive booths prior to any curing or heating process.

17. A process as claimed in claim 1 where the substrates are moved into a curing oven so that both powders may be co-cured.

18. A process as claimed in claim 14 wherein an infrared heating system brings the surface temperature of the substrate to be cured to the curing temperature immediately may be used solely or in conjunction with conventional convection cure ovens.

19. A process as claimed in claim 15 in which the curing ovens may be either gas, or electric or a combination therein.

20. A process as claimed in claim 2 wherein said substrate is moved from the step of co-curing the thermosetting powders to the step of applying an additional, or third layer in another powder coating booth.

21. A process as claimed in claim 17 wherein said additional layer of thermosetting powder is applied to the substrate for a sufficient time and volume to allow for the sufficient coating of the substrate as desired.

22. A process as claimed in claim 18 wherein said subsequent powder coating is cured in a second curing oven using an IR heating system and a convection over heating system wherein said IR system brings the surface temperature of the part to the curing temperature immediately, or solely by conventional convection or IR heating systems.
